(19) United States
(12) Patent Application Publication
(10) Pub. No.: US 2026/0336270 A1
(43) Pub. Date: Oct. 29, 2026

(54) HIGH GREASE AND PUNCTURE RESISTANT RECYCLABLE PACKAGING FILMS

(71) Applicant: PROAMPAC HOLDINGS INC., Cincinnati, OH (US)

(72) Inventors: Ebrahim Jalali Dil, Montreal (CA); Amir Saffar, Laval (CA); Joseph J. Buchanan, Appleton, WI (US); Zahra Kordjazi, Montreal (CA)

(21) Appl. No.: 19/647,382

(22) Filed: Apr. 14, 2026

Related U.S. Application Data
(60) Provisional application No. 63/789,155, filed on Apr. 15, 2025.

(51) Int. Cl. B32B 27/08; B32B 7/027; B32B 7/12; B32B 27/32

(52) U.S. Cl. CPC B32B 27/08; B32B 7/027; B32B 7/12; B32B 27/32; B32B 2250/05; B32B 2250/24; B32B 2255/10; B32B 2255/20; B32B 2307/31; B32B 2307/518; B32B 2307/581; B32B 2307/714

(57) ABSTRACT

A laminated film structure comprises a first ply comprising an outer puncture resistant layer having first and second opposing surfaces and a second ply comprising a polar grease resistant layer having first and second opposing surfaces. The first surface of the polar grease resistant layer faces toward the second surface of the outer puncture resistant layer. A barrier coating layer is disposed on the first surface of the polar grease resistant layer. A polyolefin-based film layer has first and second opposing surfaces. The first surface of the polyolefin-based film layer faces toward the second surface of the polar grease resistant layer. A first bonding layer is disposed intermediate the first and second plies. In another aspect, three-ply structures are provided. In further aspects, packaging articles formed from the laminated film structures, methods for the manufacture of the laminated film structures, and method for making packaging articles are provided.

### CROSS REFERENCE TO RELATED APPLICATION

This application claims the priority benefit of U.S. Provisional Patent Application No. 63/789,155 filed Apr. 15, 2025. The aforementioned application is incorporated herein by reference in its entirety.

### BACKGROUND

The present invention relates to packaging films and, in particular, to high grease and puncture resistant recyclable barrier packaging films, packs formed of same, and methods for making same.

High puncture, grease resistant plastic packaging film has been a commonly used product in several food packaging categories, such as packaging for bone in meat products, nuts, and pet food. Among different polymers, polyesters, including polyethylene terephthalate (PET), are known for their high puncture resistance and are commonly used in puncture resistant barrier packaging. However, it has been shown that recycling of these packages is very challenging due to the presence of polyester (e.g., PET) components. Although presently available film structures have good barrier and grease resistance properties, achieving packaging designs that meet the necessary functional requirements for grease and puncture resistant barrier film applications that are also compatible with recycling systems remains a significant challenge.

The present disclosure contemplates a new and improved film structure, pack, and method which overcome the above-referenced problems and others.

### SUMMARY

In one aspect, a laminated film structure comprises a first ply comprising an outer puncture resistant layer having a first surface and a second surface opposite the first surface and a second ply comprising a polar grease resistant layer having a first surface and a second surface opposite the first surface. The first surface of the polar grease resistant layer faces toward the second surface of the outer puncture resistant layer. A barrier coating layer is disposed on the first surface of the polar grease resistant layer. A polyolefin-based film layer has a first surface and a second surface opposite the first surface, the first surface of the polyolefin-based film layer facing toward the second surface of the polar grease resistant layer. A first bonding layer is disposed intermediate the first ply and the second ply. In a further aspect, three-ply structures are provided. In another aspect, packaging articles formed from the laminated film structures are provided. In further aspects, methods for the manufacture of the laminated film structures are provided. In another aspect, a method for forming a packaging article is provided. Also, it is well known that polyolefins have low surface energy which causes issues for applying barrier coatings on a polyolefin surface. Adding a polar grease resistance layer will improve the grease resistance of the film structure to protect against and prevent grease migration from the food-contact side to the exterior while improving surface energy and facilitate easy application of a barrier coating.

One advantage of the present development is that it meets the functional requirements for high puncture resistant, high grease resistant barrier film applications while also maintaining compatibility with recycling systems, thereby also addressing sustainability concerns.

Still further advantages and benefits of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is a cross-sectional view of an exemplary three-ply laminated film structure according to the present development.

FIG. 2 is a cross-sectional view of an exemplary two-ply laminated film structure according to the present development.

### DETAILED DESCRIPTION OF THE PREFERRED EMBODIMENT(S)

Reference will now be made in detail to presently preferred embodiments of the invention, one or more examples of which are illustrated in the accompanying drawings. Each example is provided by way of explanation of the invention, not limitation of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The terms “a” or “an,” as used herein, are defined as one or more than one. The term “another,” as used herein, is defined as at least a second or more. The terms “including” and/or “having” as used herein, are defined as comprising (i.e., open transition). As used herein, terms such as “attached,” “disposed on,” “coupled,” “operatively coupled,” and the like, are defined as indirectly or directly connected.

As used in this application, the terms “front,” “rear,” “upper,” “lower,” “upwardly,” “downwardly,” “left,” “right,” and other orientation descriptors are intended to facilitate the description of the exemplary embodiment(s) of the present invention, and are not intended to limit the structure thereof to any particular position or orientation.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5).

As used herein, the term “recyclable” means that the material can be processed in a polyolefin recycling process such that the level of non-polyolefin contaminant materials is acceptably low. As such, as used herein, recyclable refers to a film structure having high levels of polyolefin (e.g., polyethylene and propylene) and low levels of acceptable contaminants. In certain embodiments, the film structures include 70% to 99% polyolefin-based materials, by weight, e.g., 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99%, or any subrange thereof, based on the total weight of the film structure. In certain embodiments, the film structures include 75% to 99% polyolefin-based materials, by weight. In certain embodiments, the film structures include 80% to 99% polyolefin-based materials, by weight. In certain embodiments, the film structures include 85% to 99% polyolefin-based materials, by weight. In certain embodiments, the film structures include 90% to 99% polyolefin-based materials, by weight. In certain embodiments, the film structures include 95% to 99% polyolefin-based materials, by weight.

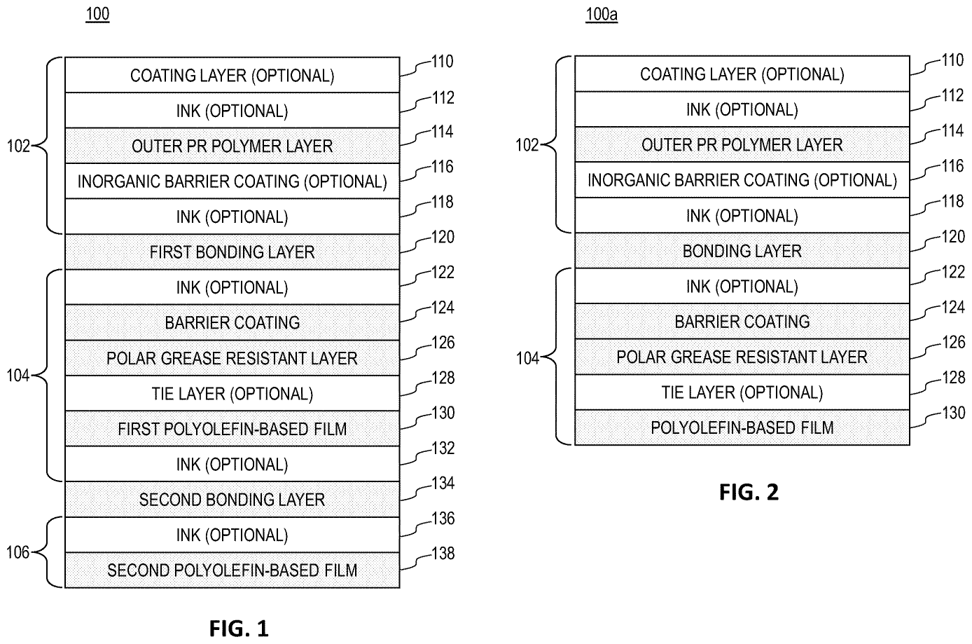

Referring now to the drawings, FIG. 1 illustrates an exemplary three-ply laminated film structure 100 comprising, a first, outer ply 102 bonded to a second, intermediate ply 104 via a first bonding layer 120, and a third, inner ply 106 bonded to the second ply 104 via a second bonding layer 134.

The first ply 102 comprises at least an outer puncture resistant polymer layer 114. The second ply 104 comprises at least a polar grease resistant layer 126 having a barrier coating layer 124 disposed on a first, outward facing surface thereof, and a first polyolefin based film layer 130 disposed on a second, inward facing surface thereof. The third ply 106 comprises at least a second polyolefin-based film layer 138. For the purposes of this specification, terms such as “outward-facing surface” and “inward-facing surface” are used to refer to the respective surfaces of each layer in the film structure 100 as determined relative to the ordering of layers from outer to inner unless specifically stated otherwise.

The outer puncture resistant polymer layer 114 is a part of the first, outer ply 102 and defines an outer layer of the film structure 100, that it is configured to be positioned away from the packaged contents when the film structure 100 is formed into a packaging article. In embodiments, the outer puncture resistant polymer layer 114 is formed of a thermoplastic polymer having puncture resistant properties. In embodiments, the outer puncture resistant polymer layer 114 is formed of a thermoplastic polymer film having a maximum puncture force which is in the range of from about 10 N to about 60 N as measured according to ASTM F1306, e.g., about 10 N, e.g., 10 N, 11 N, 12 N, 13 N, 14 N, 15 N, 16 N, 17 N, 18 N, 19 N, 20 N, 21 N, 22 N, 23 N, 24 N, 25 N, 26 N, 27 N, 28 N, 29 N, 30 N, 31 N, 32 N, 33 N, 34 N, 35 N, 36 N, 37 N, 38 N, 39 N, 40 N, 41 N, 42 N, 43 N, 44 N, 45 N, 46 N, 47 N, 48 N, 49 N, 50 N, 51 N, 52 N, 53 N, 54 N, 55 N, 56 N, 57 N, 58 N, 59 N, 60 N, and any subrange thereof, as measured according to ASTM F1306.

In certain embodiments, the outer puncture resistant polymer layer 114 is formed of a biaxially or uniaxially oriented polymer film or cast polymer film. Exemplary oriented films suitable for the outer puncture resistant polymer layer 114 include biaxially oriented nylon (BON), biaxially oriented polyethylene (BOPE), biaxially oriented polypropylene (BOPP), machine-direction oriented polyethylene (MDO PE), machine-direction oriented polypropylene (MDO PP), and biaxially oriented polyethylene terephthalate (BOPET). Exemplary cast polymer films suitable for the outer puncture resistant polymer layer 114 include cast polyamides, such as cast nylon and others.

In certain embodiments, an optional printed ink layer 112 may be disposed on the outward facing surface of the outer puncture resistant polymer layer 114. Since the ink layer 112 is disposed on the outward facing surface of the outer puncture resistant polymer layer 114, it should generally be rendered as a forward printed image.

Exemplary printing methods for the optional ink layer 112 include flexographic printing, gravure printing, ink jet printing, digital printing, and the like. Exemplary inks include water-based inks, solvent-based inks, solvent-free inks, ultraviolet (UV) curable inks, and so forth.

In certain embodiments an optional coating layer 110 may be provided on the outward facing surface of the outer puncture resistant polymer layer 114. If the optional ink layer 112 is present, the optional coating layer 110 is preferably provided over the optional ink layer 112.

In certain embodiments, the optional coating layer 110 is formed of a matte or gloss overprint varnish or lacquer to provide a desired finished appearance. In certain embodiments, the optional coating layer 110 is an energy cured coating such as an electron beam cured coating or a UV cured coating. Exemplary energy cured coating compositions include cured polyacrylate compositions formed by curing a reactive polymer composition comprising one or more monomers, oligomers, polymers, acrylates, polyacrylates, and/or polyacrylate copolymers. In certain embodiments, the optional coating layer 110 is an electron beam cured composition that includes, but is not limited to, ethoxylated trimethylolpropane triacrylates, acrylated and acrylate ester resins, polyol acrylates, trimethylolpropane triacrylates, polydimethylsiloxane acrylates, and maleic anhydrides. Other energy-cured coating compositions suitable for the optional coating layer 110 include monomers and oligomers that contain vinyl and allyl compounds, as well as monomers and oligomers that are induced into UV polymerization and curing through the mediation of photoinitiators and exposure to UV light and coatings that provide enhanced oxygen and moisture barrier properties.

In certain embodiments, the optional coating layer 110 is formed of a two-part or two-component (2K) coating composition wherein a coating layer is formed through the polymerization of two starting components, namely, a cross-linkable binder component and a cross-linking agent component, wherein the cross-linkable binder component and the cross-linking agent component are combined to form a coating composition prior to application to the film construction and wherein the reactive constituents thereof combine through a curing process.

In embodiments, the optional coating layer 110 comprises a two-part coating material formed from a coating composition comprising a cross-linkable binder and cross-linking agent, wherein the coating composition is curable at room temperature. In embodiments, the coating composition has a full curing time in the range of from about 1 day to about 15 days. The cross-linking agent chemically reacts with the cross linkable agent and, since reactions begin as soon as the cross-linkable binder and the cross-linking agent are mixed, the working time is limited such that the two-part coating is preferably mixed in batches and brought to the coating or printing station for immediate application.

In certain embodiments, the cross-linking agent comprises an isocyanate compound having at least one isocyanate group (R—N═C—O), such as 1,6-hexane diisocyanate (HDI), toluene diisocyanate (TDI), hexamethylene-di-isocyanate. The cross-linkable binder comprises a polymer selected from nitrocelluloses, polyesters, and polyurethanes. In embodiments, the polyurethane is a polyurethane having hydroxyl functional groups. In embodiments, the ratio of the cross-linkable binder to the cross-linking agent in the coating mixture is in the range of 100:10 to 100:40, by weight.

In embodiments, the two-part coating is applied using a printer at high speed, e.g., 100-500 m/minute. After applying the coating, the coated film is passed through oven/dryer to remove the solvent and then wound up on a take up roll with minimum tension on the roll to avoid passing volatile organic liquids from the coating layer to the other side of the roll. The roll is then set aside to complete the curing and reaction, e.g., for 1-15 days depending on the cure time of the two-part coating composition employed.

In embodiments, the coating weight of mixed two-part coating composition coating is in the range of 0.75 pounds per ream (1.22 grams per square meter) to 3 pounds per ream (4.88 grams per square meter) dry weight and more preferably in the range of 1.0 pounds per ream (1.63 grams per square meter) to 1.5 pounds per ream (2.44 grams per square meter) dry weight. Solvents for the cross-linkable binder and cross-linking agent include alcohols and esters, including without limitation, isopropanol, ethyl acetate, and n-propyl acetate. Exemplary two-part coating systems are commercially available through different industrial coating suppliers such as Sun Chemical Corporation of Parsippany, NJ, USA, J.M. Huber Corporation of Edison, NJ, USA, Siegwerk Druckfarben AG & Co. KGaA of Siegburg, Germany, DAW SE of Ober-Ramstadt, Germany, and others.

In certain embodiments, the outer puncture resistant polymer layer 114 is formed of a film having a thickness in the range of from about 4 microns to about 25 microns. In presently preferred embodiments, the outer puncture resistant polymer layer 114 is formed of a film having a thickness in the range of from about 8 microns to about 15 microns.

An optional inorganic barrier coating 116 is disposed on the inward facing surface of the outer puncture resistant polymer layer 114. The optional inorganic barrier coating 116 may comprise an inorganic barrier material including but not limited to inorganic oxides such as aluminum oxide (AlOx), silicon oxide (SiOx), or a combination thereof, or a metallized layer such as aluminum. The optional inorganic barrier coating 116 may be formed using physical or chemical deposition techniques, including but not limited to physical vapor deposition (PVD), chemical vapor deposition (CVD), sputtering, and the like.

In certain embodiments, an optional printed ink layer 118 may be disposed on the inward facing surface of the outer puncture resistant polymer layer 114. Since the ink layer 118 is disposed on the inward facing surface of the outer puncture resistant polymer layer 114, it should generally be rendered as a reverse printed image. Exemplary printing methods and compositions for the optional ink layer 118 may be as described above.

In embodiments where the optional inorganic barrier coating 116 is absent, the optional ink layer 118 may be disposed on the inward-facing surface of the outer puncture resistant polymer layer 114 (e.g., effected as a reverse-printed image). In embodiments where the optional inorganic barrier coating 116 is present and is substantially transparent (e.g., as in the case of a substantially transparent metal oxide coating) the optional ink layer 118 may be disposed on the inward-facing surface of the optional inorganic barrier coating 116 (e.g., effected as a reverse-printed image). In embodiments where the optional inorganic barrier layer 116 is present and is not substantially transparent (e.g., as in the case of a substantially opaque or reflective metallized coating), the printed ink layer 118 is preferably omitted in favor of the optional ink layer 112 to maintain image visibility.

Thus, the first ply 102 comprises the outer puncture resistant polymer layer 114 as well as the optional coating layer 110, optional ink layer 112, optional inorganic barrier layer 116, and optional ink layer 118. The first ply, in turn, is bonded to the second ply 104 via the first bonding layer 120.

The first bonding layer 120 may be an adhesive layer or an extruded polymer interlayer and the first ply 102 and second ply 104 can be bonded using conventional lamination techniques, such as adhesive lamination or extrusion lamination techniques. When the first bond interlayer 120 is an adhesive layer, an adhesive is applied between the plies 102 and 104 and the plies 102 and 104 are bonded under suitable conditions. The adhesive may be applied to the surface of at least one of the plies 102 and 104 via any suitable coating method, e.g., spray coating, roll coating, blade coating, or similar technique. The adhesive may be any suitable adhesive, including but not limited to single component adhesives, two component adhesives, solvent-based adhesives, solventless adhesives, water-based adhesives, acrylic adhesives, polyurethane adhesives, electron beam lamination adhesives, and UV lamination adhesives, as would be understood by persons skilled in the art.

When the first bonding layer 120 is an extrusion interlayer, the bonding layer 120 is extruded and brought onto a surface of one of the plies 102 and 104 as a melt curtain, e.g., just before the nip of lamination rollers, to laminate the plies 102 and 104. In embodiments wherein the first bonding layer 120 is an extruded polymer interlayer, the polymer may be any suitable polymer used for extrusion lamination, including low-density polyethylene (LDPE), linear low-density polyethylene (LLDPE), high-density polyethylene (HDPE), polypropylene (PP), ethylene-vinyl acetate (EVA), ethylene-methyl acrylate (EMA), ethylene-acrylic acid (EAA), ethylene-methacrylic acid (EMAA), ethylene-methyl methacrylate (EMMA), ionomers, and blends thereof, as would be understood by persons skilled in the art. The bonding layer 120 may optionally include one or more additives such as adhesion promoters, compatibilizers, stabilizers, or other functional agents to enhance processing characteristics and/or bonding performance.

The second ply 104 comprises a polar grease resistant polymer layer 126 and a first polyolefin-based film 130. An optional tie layer 128 may be disposed intermediate the polar grease resistant polymer layer 126 and the first polyolefin-based film 130 to facilitate adhesion between the layers. The polar grease resistant polymer layer 126 is disposed outwardly of the first polyolefin-based film 130. As used herein, the terms “grease resistant” or “grease resistance” refer to the character of the barrier layer in blocking or impeding the absorption, permeation, or transmission of grease or oil in any significant quantity.

In embodiments, the polar grease resistant polymer layer 126 is a polymer film which is formed by applying and drying a water-based or solvent-based coating composition containing a polar, grease resistant polymer wherein the coating composition is applied to the outward facing surface of the first polyolefin-based film 130, wherein the first polyolefin-based film 130 comprises as pre-formed substrate. The coating composition may contain the polar, grease resistant polymer in a dissolved, dispersed, or emulsified form.

In further embodiments, the polar grease resistant polymer layer 126, the first polyolefin-based film 130, and optional tie layer 128 grease/tie/polyolefin, comprises a coextruded structure formed via a coextrusion process in which the first polyolefin-based film 130 and the polar grease resistant polymer layer 126, and optional tie layer 128 are formed simultaneously by co-extruding the respective molten polymers using an extruder equipped with a multilayer die. Preferably, the optional tie layer 128 is coextruded between the first polyolefin-based film 130 and the polar grease resistant polymer layer 126 to enhance adhesion between the layers.

In embodiments, the polar grease resistant polymer layer 126 is formed of a polar, grease resistant polymer material such as polyamide, e.g., nylon, nylon 6, nylon 66, nylon 6/66, nylon 11, nylon 12, nylon 6/12, nylon 610, nylon blends, ethylene vinyl alcohol copolymer (EVOH), polyvinyl alcohol (PVOH), ethylene vinyl acetate (EVA).

Other materials suitable for the polar grease resistant polymer layer 126 include copolymers of alkylenes (preferably lower alkylenes) and unsaturated carboxylic acids (preferably lower unsaturated carboxylic acids), including but not limited to ethylene-acrylic acid (EAA), ethylene-methacrylic acid (EMAA), propylene-acrylic acid, propylene-methacrylic acid, butylene-acrylic acid, and butylene-methacrylic acid copolymers. Still further materials suitable for the polar grease resistant polymer layer 126 include copolymers of alkylenes (preferably lower alkylenes) and alkyl esters derived from unsaturated carboxylic acids (preferably lower alkyl esters from lower unsaturated carboxylic acids), including but not limited to ethylene-methyl acrylate (EMA), ethylene-ethyl acrylate (EEA), ethylene-propyl acrylate, ethylene-butyl acrylate (EBA), propylene-methyl acrylate, propylene-ethyl acrylate, propylene-propyl acrylate, propylene-butyl acrylate, ethylene-methyl methacrylate (EMMA), ethylene-ethyl methacrylate (EEMA), ethylene-propyl methacrylate, ethylene-butyl methacrylate (EBAM), propylene-methyl methacrylate, propylene-ethyl methacrylate, propylene-propyl methacrylate, and propylene-butyl methacrylate copolymers.

The optional tie layer 128 comprises a tie resin, which may include, for example:
(a) polyolefins grafted with carboxylic acids or anhydride derivatives, preferably polyolefins grafted with lower carboxylic acids or lower anhydride derivatives, including but not limited to polyethylene (PE) grafted with acrylic acid (AA) (PE-g-AA), polyethylene (PE) grafted with maleic anhydride (MA) (PE-g-MA) polyethylene (PE) grafted with methacrylic acid (MAA) (PE-g-MAA), polypropylene (PP) grafted with acrylic acid (AA) (PP-g-AA), polypropylene (PP) grafted with maleic anhydride (MA) (PP-g-MA), and polypropylene (PP) grafted with methacrylic acid (MAA) (PP-g-MAA);
(b) copolymers of alkylenes, preferably lower alkylenes, and unsaturated carboxylic acids (preferably lower unsaturated carboxylic acids), including but not limited to ethylene-acrylic acid (EAA) copolymer, ethylene-methacrylic acid (EMAA) copolymer, propylene-acrylic acid copolymer, propylene-methacrylic acid copolymer, butylene-acrylic acid copolymer, butylene-methacrylic acid copolymer;
(c) copolymers of alkylenes, preferably lower alkylenes, and alkyl esters derived from unsaturated carboxylic acids (preferably lower alkyl esters derived from lower unsaturated carboxylic acids), including without limitation, ethylene-methyl acrylate copolymer (EMA), ethylene-ethyl acrylate copolymer (EEA), ethylene-propyl acrylate copolymer, ethylene-butyl acrylate copolymer (EBA), propylene-methyl acrylate copolymer, propylene-ethyl acrylate copolymer, propylene-propyl acrylate copolymer, propylene-butyl acrylate copolymer, ethylene-methyl methacrylate copolymer (EMMA), ethylene-ethyl methacrylate copolymer (EEMA), ethylene-propyl methacrylate copolymer, ethylene-butyl methacrylate copolymer (EBAM), propylene-methyl methacrylate copolymer, propylene-ethyl methacrylate copolymer, propylene-propyl methacrylate copolymer, propylene-butyl methacrylate copolymer; or
(d) terpolymers of alkylenes, unsaturated carboxylic acids or alkyl esters derived therefrom, and anhydrides, more preferably terpolymers of lower alkylenes, lower unsaturated carboxylic acids or lower alkyl esters derived therefrom, and lower anhydrides, including but not limited to ethylene-butyl acrylate-maleic anhydride terpolymer, ethylene-acrylic acid-maleic anhydride terpolymer, ethylene-methacrylic acid-maleic anhydride terpolymer, ethylene-methyl acrylate-maleic anhydride terpolymer, ethylene-ethyl acrylate-maleic anhydride terpolymer, ethylene-propyl acrylate-maleic anhydride terpolymer, ethylene-methyl methacrylate-maleic anhydride terpolymer, ethylene-ethyl methacrylate-maleic anhydride terpolymer, ethylene-propyl methacrylate-maleic anhydride terpolymer, ethylene-butyl methacrylate-maleic anhydride terpolymer, propylene-acrylic acid-maleic anhydride terpolymer, propylene-methacrylic acid-maleic anhydride terpolymer, propylene-methyl acrylate-maleic anhydride terpolymer, propylene-ethyl acrylate-maleic anhydride terpolymer, propylene-propyl acrylate-maleic anhydride terpolymer, propylene-butyl acrylate-maleic anhydride terpolymer, propylene-methyl methacrylate-maleic anhydride terpolymer, propylene-ethyl methacrylate-maleic anhydride terpolymer, propylene-propyl methacrylate-maleic anhydride terpolymer, propylene-butyl methacrylate-maleic anhydride terpolymer;
(f) copolymers of alkylenes, preferably lower alkylene, and vinyl acetate, including but not limited to ethylene vinyl acetate (EVA), vinyl acetate ethylene (VAE), propylene vinyl acetate (PVA), and vinyl acetate propylene (VAP); or
(f) any combinations of the foregoing.

In certain embodiments, the optional tie layer 128 may consist of, consist essentially of, or comprise a tie resin either alone or in combination with one or more additional polymer components. In certain embodiments, the tie resin is present as the primary or sole constituent of the tie layer. In other embodiments, the tie resin is blended with one or more diluent polymers. Suitable diluent polymers include, but are not limited to, polyolefin-based polymers such as polyethylene homopolymers and copolymers, including low-density polyethylene (LDPE), linear low-density polyethylene (LLDPE), very low-density polyethylene (VLDPE), ultra-low-density polyethylene (ULDPE), high-density polyethylene (HDPE), and medium-density polyethylene (MDPE), as well as polypropylene homopolymers and copolymers, and blends or combinations thereof.

The tie resin may be present in any amount sufficient to effectuate adhesion between the polar grease resistant layer 126 and the first polyolefin-based film 130, including but not limited to from about 10% by weight to about 100% by weight, more preferably from about 25% by weight to about 75% by weight, based on the total weight of the optional tie layer 128. It is expressly contemplated that any ratio of tie resin to diluent polymer that yields a functionally effective tie layer, regardless of specific weight percent, falls within the scope of the present disclosure.

The thickness of the polar grease resistant polymer layer 126 comprises a fraction of the thickness of the film structure 100 in its entirety, provided that the polar grease resistant polymer layer 126 comprises 15% or less by weight of the film structure 100 in its entirety. In certain embodiments, the polar grease resistant polymer layer 126 comprises from about 1% to about 15% by weight (e.g., about 1%, 2%, 3%, 4%, 5%, 6%, 7%, 8%, 9%, 10%, 11%, 12%, 13%, 14%, or 15% by weight, or any subrange thereof) of the film structure 100 in its entirety.

In embodiments, the first polyolefin-based film 130 comprises polyethylene, polypropylene, or blends or copolymers thereof. The first polyolefin-based film 130 may be a monolayer or multilayer structure. Examples of polyolefin-based polymers include polyethylene (PE), polypropylene (PP), polyolefin blends, polyolefin copolymers, low-density polyethylene (LDPE), very low-density polyethylene (VLDPE), ultra-low-density polyethylene (ULDPE), linear low-density polyethylene (LLDPE), medium density polyethylene (MDPE), linear medium density polyethylene (LMDPE), high-density polyethylene (HDPE), metallocene polyethylene including metallocene linear low-density polyethylene (mLLDPE), polyolefin plastomer (POP), cyclic olefin copolymers (COC), cast polypropylene (CPP), ethylene-propylene copolymer (EPC), and other polyolefin materials, including post-consumer recycled (PCR) polyolefins, as well as blends, coextrusions, and laminations of any of the foregoing.

The second ply 104 may be formed using any suitable method. In certain embodiments, the structure 104 is formed by a coextrusion process in which the polar grease resistant layer 126 and the first polyolefin-based film layer 130 are coextruded, with or without the optional tie layer 128 therebetween, to form an integrated film structure. The barrier coating layer 124 is applied to the outward facing surface of the polar grease resistant layer 126.

In certain embodiments, the second ply 104 includes an optional printed ink layer 122 disposed on the outward facing surface of the barrier coating 124 The optional ink layer 122 may be formed using any of the methods and materials as described above. Since the optional ink layer 122 is on an outward facing surface, it should generally be effected as a forward printed image. In embodiments, the optional ink layer 122 is only present if the optional ink layers 118 and 112 are absent and the optional inorganic barrier coating layer 116 is absent or substantially transparent.

In certain embodiments, the second ply 104 includes an optional printed ink layer 132 that may be disposed on the inward facing surface of the first polyolefin based film layer 130. The optional ink layer 132 may be formed using any of the methods and materials as described above. Since the optional ink layer 132 is on an inward facing surface, it should generally be effected as a reverse printed image. In embodiments, the optional ink layer 132 is only present if the optional ink layers 122, 118, and 112 are absent and the optional inorganic barrier coating layer 116 is absent or substantially transparent.

The barrier coating layer 124 may be an inorganic barrier material, which may be formed using any of the inorganic materials and application methods described above. Alternatively, the barrier coating layer 124 may be formed of a suitable polymer barrier coating material, such as a suitable gas/oxygen barrier polymer material. In preferred embodiments, the polymer barrier coating material is PVOH.

In other embodiments, the first polyolefin-based film layer 130 may be provided as a preformed web of material and the polar grease resistant layer 126 may be subsequently applied as an extrusion coating onto the outward-facing surface of the first polyolefin-based film layer 130 using an extrusion coating process. In yet other embodiments, the polar grease resistant layer 126 may be provided as a preformed web of material and the first polyolefin-based film layer 130 may be subsequently applied as an extrusion coating onto the outward-facing surface of the first polyolefin-based film layer 130 using an extrusion coating process. In still further embodiments, the polar grease resistant layer 126 and the optional tie layer 128 may be coextruded using a coextrusion coating process onto the outward-facing surface of the first polyolefin-based film 130 which has been provided as a preformed web, with the optional tie layer 128 disposed intermediate the layers 126 and 130. In yet other embodiments, the first polyolefin-based film 130 and the optional tie layer 128 may be coextruded using a coextrusion coating process onto the inward-facing surface of the polar grease resistant layer 126 which has been provided as a preformed web, with the optional tie layer 128 disposed intermediate the layers 126 and 130. Alternatively, the polar grease resistant layer 126 and the first polyolefin-based film layer 130 may both be provided as separate preformed webs wherein the ply structure 104 is assembled by extrusion lamination, wherein the molten tie layer material forming the optional tie layer 128 is applied as a melt layer between the webs forming the layers 126 and 130 using an extrusion lamination process.

The application of the barrier coating layer 124 may vary depending on its composition and the method by which the underlying polar grease resistant layer 126 is introduced into the ply structure 104. In embodiments wherein the barrier coating layer 124 is an inorganic barrier, it may be applied to the outward-facing surface of the polar grease resistant layer 126 in a separate coating step performed after the polar grease resistant layer 126 and the first polyolefin-based film layer 130 (and, if present, the optional tie layer 128) are combined. Similarly, where the barrier coating layer 124 is a polymer barrier, it may also be applied to the polar grease resistant layer 126 in a separate coating step using any suitable polymer coating method, such as roll coating, extrusion coating, aqueous or solvent based dispersion or emulsion coating and drying, slot-die coating, spray coating, blade coating, gravure coating, or the like.

In further embodiments, wherein the barrier coating layer 124 is an organic or inorganic barrier material and wherein the polar grease resistant layer 126 is provided as a preformed web, the barrier coating layer 124 may be applied prior to lamination in a coating step conducted before the polar grease resistant layer 126 is combined with the first polyolefin-based layer 130 (and, if present, the optional tie layer 128).

In yet another embodiment, wherein the barrier coating layer 124 is formed of a polymeric material, the barrier coating layer 124, polar grease resistant layer 126 (and, if present, the optional tie layer 128), and the first polyolefin-based film layer 130 may be formed simultaneously via a coextrusion process.

In still further embodiments, wherein the barrier coating layer 124 is formed of a polymeric material, the barrier coating layer 124, polar grease resistant layer 126, and, if present, the optional tie layer 128, may be applied to the outward facing surface of a preformed web comprising the first polyolefin-based film layer 130 via a coextrusion process.

In embodiments, wherein the barrier coating layer 124 is formed of a polymeric material and when the polar grease resistant layer 126 is applied as an extrusion coating or coextrusion coating onto a preformed web comprising the first polyolefin-based film layer 130, the barrier coating layer 124 may either be coextruded together with the polar grease resistant layer 126 and, if present, the optional tie layer 128, or applied separately in a downstream coating step.

The third ply 106 includes a second polyolefin-based film 138 and optionally includes an optional ink layer 136 on the inward facing surface thereof. The optional ink layer 136 may be formed using any of the methods and materials as described above. Since the optional ink layer 136 is on an outward facing surface, it should generally be effected as a forward printed image. In embodiments, the optional ink layer 136 is only present if the optional ink layers 132, 122, 118, and 112 are absent and the optional inorganic barrier coating layer 116 is absent or substantially transparent.

The second polyolefin-based film layer 138 has an inward facing surface which defines an innermost surface of the film structure 100. The second polyolefin-based film layer 138 may comprise a monolayer or multilayer structure, and may comprise any one or more of the polyolefin-based materials as described above by way of reference to the first polyolefin-based layer 130, including combinations, blends, laminations, and coextrusions thereof, provided that at least the innermost surface of the second polyolefin-based film layer 138 is heat sealable to itself under sealing conditions so as to be capable of forming or otherwise configured to form a heat seal. As used herein, the phrase “heat sealable to itself under sealing conditions” refers to the ability of the sealing surface to form a bond, either peelable or non-peelable, and optionally gast-tight, with an opposing surface of the same composition or layer type when subjected to appropriate heat, pressure, and dwell time parameters typical of conventional heat sealing equipment.

In certain embodiments, at least the innermost surface of the second polyolefin-based film layer 138 is heat sealable to itself under sealing conditions so as to be capable of forming a lock seal or weld seal under suitable sealing conditions. In embodiments, the lock or weld seal provides a seal strength in the range of about 4000 gf/in and or greater. Exemplary suitable sealing conditions for forming a lock or weld seal include a sealing pressure of about 40 psi, a sealing temperature of about 300 °F, and a dwell time of about 0.5 seconds.

In certain embodiments, at least the innermost surface of the second polyolefin-based film layer 138 is heat sealable to itself under sealing conditions so as to be capable of forming a peelable seal under suitable sealing conditions. In embodiments, the peelable seal provides a seal strength in the range of from about 500 gf/in to about 4000 gf/in. Exemplary suitable sealing conditions for forming a peelable seal include a sealing pressure of about 40 psi, a sealing temperature of about 300 °F, and a dwell time of about 0.5 second.

The second ply 104 and third ply 106 are laminated using a second bonding layer 134. The second bonding layer 134, which may be the same as or different than the first bonding layer 120, may be formed of an adhesive material or polymer interlayer material as described above by way of reference to the first bonding layer 120. In embodiments, the bonding of the first ply 102 to the second ply 104 and the bonding of the second ply 104 to the third ply 106 may be performed concurrently or sequentially, and in any order. In some embodiments, the plies 102, 104, and 106 may be joined in a single pass or process line, for example, through tandem or inline lamination.

In certain embodiments, a first lamination step may be used to bond the first ply 102 to the second ply 104, wherein the resulting intermediate structure is subsequently laminated to the third ply 106 in a second lamination step, which may be the same or different than the first lamination step, and which may be performed in a separate, downstream operation or on a distinct process line.

In other embodiments, a first lamination step may be used to bond the second ply 102 to the third ply 106, wherein the resulting intermediate structure is subsequently laminated to the first ply 102 in a second lamination step, which may be the same or different than the first lamination step, and which may be performed in a separate, downstream operation or on a distinct process line.

Exemplary structures for the film structure 100 are shown in Table 1 below, wherein the order of layers from left to right corresponds to the sequence of layers from the outermost surface of the film structure 100 to the innermost, product- or seal-facing surface. “OCL” refers to the optional outer coating layer 110, “Ink” refers to the optional ink layers 112, 118, 122, 132, and 136, as appropriate based on its position within the structure, “OPL” refers to the outer puncture resistant polymer layer 114, “IBCL” refers to the optional inorganic coating layer 116, “Bond” refers to the first and second bonding layers 120 and 134, as appropriate based on its position within the structure, “Barrier” refers to the barrier coating layer 124, “GRL” refers to the polar grease-resistant layer 126, “Tie” refers to the optional tie layer 128, and “PO-based” refers to the first and second polyolefin-based films 130 and 138, as appropriate based on position within the structure.

TABLE 1
OCL/Ink/OPL/IBCL/Bond/Barrier/GRL/Tie/PO-based/Bond/PO-based
OCL/Ink/OPL/IBCL/Bond/Barrier/GRL/PO-based/Bond/PO-based
OCL/Ink/OPL/Bond/Barrier/GRL/Tie/PO-based/Bond/PO-based
OCL/Ink/OPL/Bond/Barrier/GRL/PO-based/Bond/PO-based
OCL/OPL/IBCL/Ink/Bond/Barrier/GRL/Tie/PO-based/Bond/PO-based
OCL/OPL/IBCL/Ink/Bond/Barrier/GRL/PO-based/Bond/PO-based
OCL/OPL/IBCL/Bond/Ink/Barrier/GRL/Tie/PO-based/Bond/PO-based
OCL/OPL/IBCL/Bond/Ink/Barrier/GRL/PO-based/Bond/PO-based
OCL/OPL/IBCL/Bond/Barrier/GRL/Tie/PO-based/Ink/Bond/PO-based
OCL/OPL/IBCL/Bond/Barrier/GRL/Tie/PO-based/Bond/Ink/PO-based
OCL/OPL/IBCL/Bond/Barrier/GRL/Tie/PO-based/Bond/PO-based
OCL/OPL/IBCL/Bond/Barrier/GRL/PO-based/Ink/Bond/PO-based
OCL/OPL/IBCL/Bond/Barrier/GRL/PO-based/Bond/Ink/PO-based
OCL/OPL/IBCL/Bond/Barrier/GRL/PO-based/Bond/PO-based
OCL/OPL/Ink/Bond/Barrier/GRL/Tie/PO-based/Bond/PO-based
OCL/OPL/Ink/Bond/Barrier/GRL/PO-based/Bond/PO-based
OCL/OPL/Bond/Ink/Barrier/GRL/Tie/PO-based/Bond/PO-based
OCL/OPL/Bond/Ink/Barrier/GRL/PO-based/Bond/PO-based
OCL/OPL/Bond/Barrier/GRL/Tie/PO-based/Ink/Bond/PO-based
OCL/OPL/Bond/Barrier/GRL/Tie/PO-based/Bond/Ink/PO-based
OCL/OPL/Bond/Barrier/GRL/Tie/PO-based/Bond/PO-based
OCL/OPL/Bond/Barrier/GRL/PO-based/Ink/Bond/PO-based
OCL/OPL/Bond/Barrier/GRL/PO-based/Bond/Ink/PO-based
OCL/OPL/Bond/Barrier/GRL/PO-based/Bond/PO-based
Ink/OPL/IBCL/Bond/Barrier/GRL/Tie/PO-based/Bond/PO-based
Ink/OPL/IBCL/Bond/Barrier/GRL/PO-based/Bond/PO-based
Ink/OPL/Bond/Barrier/GRL/Tie/PO-based/Bond/PO-based
Ink/OPL/Bond/Barrier/GRL/PO-based/Bond/PO-based
OPL/IBCL/Ink/Bond/Barrier/GRL/Tie/PO-based/Bond/PO-based
OPL/IBCL/Ink/Bond/Barrier/GRL/PO-based/Bond/PO-based
OPL/IBCL/Bond/Ink/Barrier/GRL/Tie/PO-based/Bond/PO-based
OPL/IBCL/Bond/Ink/Barrier/GRL/PO-based/Bond/PO-based
OPL/IBCL/Bond/Barrier/GRL/Tie/PO-based/Ink/Bond/PO-based
OPL/IBCL/Bond/Barrier/GRL/Tie/PO-based/Bond/Ink/PO-based
OPL/IBCL/Bond/Barrier/GRL/Tie/PO-based/Bond/PO-based
OPL/IBCL/Bond/Barrier/GRL/PO-based/Ink/Bond/PO-based
OPL/IBCL/Bond/Barrier/GRL/PO-based/Bond/Ink/PO-based
OPL/IBCL/Bond/Barrier/GRL/PO-based/Bond/PO-based
OPL/Ink/Bond/Barrier/GRL/Tie/PO-based/Bond/PO-based
OPL/Ink/Bond/Barrier/GRL/PO-based/Bond/PO-based
OPL/Bond/Ink/Barrier/GRL/Tie/PO-based/Bond/PO-based
OPL/Bond/Ink/Barrier/GRL/PO-based/Bond/PO-based
OPL/Bond/Barrier/GRL/Tie/PO-based/Ink/Bond/PO-based
OPL/Bond/Barrier/GRL/Tie/PO-based/Bond/Ink/PO-based
OPL/Bond/Barrier/GRL/Tie/PO-based/Bond/PO-based
OPL/Bond/Barrier/GRL/PO-based/Ink/Bond/PO-based
OPL/Bond/Barrier/GRL/PO-based/Bond/Ink/PO-based
OPL/Bond/Barrier/GRL/PO-based/Bond/PO-based

Referring now to FIG. 2, there is shown an exemplary two-ply laminated film structure 100a comprising, a first, outer ply 102 bonded to a second ply 104 via a bonding layer 120.

The film structure 100a comprises, in order from outer layer to inner layer, at least an outer puncture resistant polymer layer 114 as the first ply 102; the bonding layer 120; and a barrier coating layer 124, a polar grease resistant layer 126, and a polyolefin based film layer 130, as the second ply 104. Terms such as “outward-facing surface” and “inward-facing surface” are used herein to refer to the respective surfaces of each layer in the film structure 100a as determined relative to the ordering of layers from outer to inner as described above unless specifically stated otherwise.

For the sake of clarity and brevity, components and layers that appear in multiple figures are identified using like reference numerals throughout the drawings. Unless otherwise indicated, the description of any reference numeral provided in connection with FIG. 1 is equally applicable to the same reference numeral appearing in FIG. 2, except as specifically stated otherwise. Thus, the two-ply film structure 100a appearing in FIG. 2 is structurally similar to the three-ply structure 100 appearing in FIG. 1, with the exception that the third ply 106, second bonding layer 134, and optional ink layers 132 and 136 of the structure 100 of FIG. 1 are omitted in the structure 100a of FIG. 2.

Therefore, the materials, constructions, and methods described above with in connection to FIG. 1 with respect to the ply 102, ply 104, optional outer coating layer 110, optional ink layer 112, outer puncture resistant layer 114, optional inorganic barrier coating layer, 116, optional ink layer 118, bonding layer 120, optional ink layer 122, barrier coating layer 124, polar grease resistant layer 126, optional tie layer 128 and polyolefin-based film layer 130 will be understood to apply equally to the corresponding components of FIG. 2 and which above description is incorporated here by reference for all purposes. It will be recognized that the inward facing surface of the polyolefin based film 130 appearing in FIG. 2 defines an innermost surface of the film structure 100a such that at least the innermost surface of the polyolefin-based film layer 130 should be heat sealable to itself under sealing conditions so as to form a hermetic seal; whereas, the polyolefin based film 130 of the film structure 100 appearing in FIG. 1 is a core layer such that it is not necessary that it exhibit heat seal properties, although it is contemplated that heat sealable materials may be used.

Exemplary structures for the film structure 100a are shown in TABLE 2 below, wherein the order of layers from left to right corresponds to the sequence of layers from the outermost surface of the film structure 100a to the innermost, product- or seal-facing surface thereof. “OCL” refers to the optional outer coating layer 110, “Ink” refers to the optional ink layers 112, 118, and 122, as appropriate based on its position within the structure, “OPL” refers to the outer puncture resistant polymer layer 114, “IBCL” refers the optional inorganic coating layer 116, “Bond” refers to the bonding layer 120, “Barrier” refers to the barrier coating layer 124, “GRL” refers to the polar grease-resistant layer 126, “Tie” refers to the optional tie layer 128, and “PO-based” refers to the polyolefin-based film 130.

TABLE 2

OCL/Ink/OOL/IBCL/Bond/Barrier/GRL/Tie/PO-based
OCL/Ink/OOL/IBCL/Bond/Barrier/GRL/PO-based
OCL/Ink/OOL/Bond/Barrier/GRL/Tie/PO-based
OCL/Ink/OOL/Bond/Barrier/GRL/PO-based
OCL/OOL/IBCL/Ink/Bond/Barrier/GRL/Tie/PO-based
OCL/OOL/IBCL/Ink/Bond/Barrier/GRL/PO-based
OCL/OOL/IBCL/Bond/Ink/Barrier/GRL/Tie/PO-based
OCL/OOL/IBCL/Bond/Ink/Barrier/GRL/PO-based
OCL/OOL/IBCL/Bond/Barrier/GRL/Tie/PO-based
OCL/OOL/IBCL/Bond/Barrier/GRL/PO-based
OCL/OOL/Ink/Bond/Barrier/GRL/Tie/PO-based
OCL/OOL/Ink/Bond/Barrier/GRL/PO-based
OCL/OOL/Bond/Ink/Barrier/GRL/Tie/PO-based
OCL/OOL/Bond/Ink/Barrier/GRL/PO-based
OCL/OOL/Bond/Barrier/GRL/Tie/PO-based
OCL/OOL/Bond/Barrier/GRL/PO-based
Ink/OOL/IBCL/Bond/Barrier/GRL/Tie/PO-based
Ink/OOL/IBCL/Bond/Barrier/GRL/PO-based
Ink/OOL/Bond/Barrier/GRL/Tie/PO-based
Ink/OOL/Bond/Barrier/GRL/PO-based
OOL/IBCL/Ink/Bond/Barrier/GRL/Tie/PO-based
OOL/IBCL/Ink/Bond/Barrier/GRL/PO-based
OOL/IBCL/Bond/Ink/Barrier/GRL/Tie/PO-based
OOL/IBCL/Bond/Ink/Barrier/GRL/PO-based
OOL/IBCL/Bond/Barrier/GRL/Tie/PO-based
OOL/IBCL/Bond/Barrier/GRL/PO-based
OOL/Ink/Bond/Barrier/GRL/Tie/PO-based
OOL/Ink/Bond/Barrier/GRL/PO-based
OOL/Bond/Ink/Barrier/GRL/Tie/PO-based
OOL/Bond/Ink/Barrier/GRL/PO-based
OOL/Bond/Barrier/GRL/Tie/PO-based
OOL/Bond/Barrier/GRL/PO-based

The film structures described herein may be used to form a wide variety of articles, including but not limited to packaging materials such as pouches, films, bags, and others. In certain embodiments, a method for making such articles includes converting the film structures 100, 100a into a desired shape or form, such as by cutting, folding, or the like, followed by heat sealing at least a portion of the structure to a corresponding surface to create a partially closed package or a fully closed and sealed package. While the present disclosure is primarily directed to the composition and structure of the film structures, it is expressly contemplated that the films in accordance with the present disclosure may be used in downstream manufacturing or packaging operations to produce finished articles.

The invention has been described with reference to the preferred embodiment. Modifications and alterations will occur to others upon a reading and understanding of the preceding detailed description. Accordingly, the above description should be understood as illustrative and not restrictive in nature.

1. A laminated film structure, comprising:
a first ply comprising an outer puncture resistant layer having a first surface and a second surface opposite the first surface;
a second ply comprising a polar grease resistant layer having a first surface and a second surface opposite the first surface, the first surface of the polar grease resistant layer facing toward the second surface of the outer puncture resistant layer;
a barrier coating layer disposed on the first surface of the polar grease resistant layer;
a polyolefin-based film layer having a first surface and a second surface opposite the first surface, the first surface of the polyolefin-based film layer facing toward the second surface of the polar grease resistant layer; and
a first bonding layer disposed intermediate the first ply and the second ply.

2. The laminated film structure of claim 1, wherein the outer puncture resistant layer is formed of a polymeric film material having a maximum puncture force in the range of from about 10 N to about 60 N, as measured according to ASTM F1306.

3. The laminated film structure of claim 2, wherein the outer puncture resistant layer comprises a material selected from the group consisting of a biaxially oriented polymer film, a uniaxially oriented polymer film, and a cast polymer film, a biaxially oriented nylon (BON) film, a biaxially oriented polyethylene (BOPE) film, a biaxially oriented polypropylene (BOPP) film, a machine-direction oriented polyethylene (MDO PE) film, a biaxially oriented polyethylene terephthalate (BOPET) film, a cast polyamide film, and a cast nylon film.

4. (canceled)

5. The laminated film structure of claim 1, further comprising one or both of:
the first ply comprises an outer coating layer disposed on the first surface of the outer puncture resistant layer and, optionally, an ink layer disposed between the first surface of the outer puncture resistant layer and the outer coating layer; and
the first ply comprises an outer coating layer comprising a material selected from the group consisting of an energy cured coating and a two-component coating material.

6. (canceled)

7. The laminated film structure of claim 1, further comprising one or more of:
the first ply comprises an inorganic barrier coating disposed on the second surface of the outer puncture resistant layer and, optionally, an ink layer disposed on the inorganic barrier coating:
the first ply comprises an inorganic barrier coating selected from the group consisting of a metallized layer, an inorganic oxide coating, an aluminum oxide (AlOx) coating, a silicon oxide (SiOx) coating, and combinations thereof; and
the barrier coating layer is selected from the group consisting of a metallized layer, an inorganic oxide coating, an aluminum oxide (AlOx) coating, a silicon oxide (SiOx) coating, a polymer barrier coating material, a polyvinyl alcohol (PVOH) coating, and combinations thereof.

8. (canceled)

9. The laminated film structure of claim 1, wherein the first bonding layer is selected from an adhesive layer and an extrusion-bonded layer.

10. The laminated film structure of claim 1, further comprising an ink layer disposed between the barrier coating layer and the first bonding layer.

11. The laminated film structure of claim 1, further comprising one or both of:
the polar grease resistant layer comprises a material selected from the group consisting of polyamides, nylons, nylon, nylon 6, nylon 66, nylon 6/66, nylon 11, nylon 12, nylon 6/12, nylon 610, nylon blends, ethylene vinyl alcohol copolymer (EVOH), polyvinyl alcohol (PVOH), ethylene vinyl acetate (EVA), copolymers of alkylenes and unsaturated carboxylic acids, acrylic acid (EAA) copolymer, ethylene-methacrylic acid (EMAA) copolymer, propylene-acrylic acid copolymer, propylene-methacrylic acid copolymer, butylene-acrylic acid copolymer, butylene-methacrylic acid copolymer, copolymers of alkylenes and alkyl esters derived from unsaturated carboxylic acids, ethylene-methyl acrylate (EMA) copolymer, ethylene-ethyl acrylate (EEA) copolymer, ethylene-propyl acrylate copolymer, ethylene-butyl acrylate (EBA) copolymer, propylene-methyl acrylate copolymer, propylene-ethyl acrylate copolymer, propylene-propyl acrylate copolymer, propylene-butyl acrylate copolymer, ethylene-methyl methacrylate (EMMA) copolymer, ethylene-ethyl methacrylate (EEMA) copolymer, ethylene-propyl methacrylate copolymer, ethylene-butyl methacrylate (EBAM) copolymer, propylene-methyl methacrylate copolymer, propylene-ethyl methacrylate copolymer, propylene-propyl methacrylate copolymer, and propylene-butyl methacrylate copolymer; and
the polar grease resistant layer does not exceed 15% by weight based on a total weight of the laminated film structure.

12-13. (canceled)

14. The laminated film structure of claim 1, further comprising a tie layer disposed between the polar grease resistant layer and the first polyolefin-based film layer.

15. The laminated film structure of claim 1, wherein the first polyolefin-based film layer comprises a material selected from the group consisting of polyethylene homopolymers, polypropylene homopolymers, polyethylene/polypropylene blends, polyethylene copolymers, polypropylene copolymers, copolymers of ethylene and propylene, low-density polyethylene (LDPE), very low-density polyethylene (VLDPE), ultra-low-density polyethylene (ULDPE), linear low-density polyethylene (LLDPE), medium density polyethylene (MDPE), linear medium density polyethylene (LMDPE), high-density polyethylene (HDPE), metallocene polyethylene, metallocene linear low-density polyethylene (mLLDPE), polyolefin plastomer (POP), cyclic olefin copolymers (COC), cast polypropylene (CPP), ethylene-propylene copolymer (EPC), post-consumer recycled (PCR) polyolefins, as well as blends, coextrusions, and laminations of any of the foregoing.

16. The laminated film structure of claim 1, wherein the second surface of the first polyolefin-based film layer is heat sealable to itself under sealing conditions.

17. The laminated film structure of claim 1, further comprising:
a third ply comprising a second polyolefin-based film layer having a first surface and a second surface opposite the first surface, the first surface of the second polyolefin-based film facing toward the second ply; and
a second bonding layer disposed intermediate the second ply and the third ply.

18. The laminated film structure of claim 17, further comprising an ink layer disposed between the second polyolefin-based film layer and the second bonding layer.

19. The laminated film structure of claim 17, wherein the second polyolefin-based film layer comprises a material selected from the group consisting of polyethylene homopolymers, polypropylene homopolymers, polyethylene/polypropylene blends, polyethylene copolymers, polypropylene copolymers, copolymers of ethylene and propylene, low-density polyethylene (LDPE), very low-density polyethylene (VLDPE), ultra-low-density polyethylene (ULDPE), linear low-density polyethylene (LLDPE), medium density polyethylene (MDPE), linear medium density polyethylene (LMDPE), high-density polyethylene (HDPE), metallocene polyethylene, metallocene linear low-density polyethylene (mLLDPE), polyolefin plastomer (POP), cyclic olefin copolymers (COC), cast polypropylene (CPP), ethylene-propylene copolymer (EPC), post-consumer recycled (PCR) polyolefins, as well as blends, coextrusions, and laminations of any of the foregoing.

20. The laminated film structure of claim 17, wherein the second surface of the first polyolefin-based film layer is heat sealable to itself under sealing conditions.

21. The laminated film structure of claim 1, further comprising one or both of:
the laminated film structure is recyclable in a polyolefin-compatible recycling stream; and
the laminated film structure comprises from about 70% by weight to about 99% by weight of polyolefin-based polymer materials.

22. (canceled)

23. A packaging article formed of the laminated film structure according to claim 1.

24. A method for forming a laminated film structure, comprising:
providing a first ply comprising an outer puncture resistant layer having a first surface and a second surface opposite the first surface;
providing a second ply comprising a polar grease resistant layer having a first surface and a second surface opposite the first surface;
the second ply comprising a barrier layer disposed on the first surface of the polar grease resistant layer and a first polyolefin based film layer disposed on the second surface of the polar grease resistant layer; and
laminating the first ply to the second ply using a first bonding layer, wherein the barrier layer is oriented to face toward the first bonding layer.

25-39. (canceled)

40. The method of claim 24, further comprising:
a third ply comprising a second polyolefin-based film layer having a first surface and a second surface opposite the first surface, the first surface of the second polyolefin-based film facing toward the second ply; and
a second bonding layer disposed intermediate the second ply and the third ply.

41-42. (canceled)

43. The method of claim 40, wherein the second surface of the first polyolefin-based film layer is heat sealable to itself under sealing conditions.

44. The method of claim 24, further comprising:
forming a packaging article from the laminated film structure.
